(19) United States
(12) Patent Application Publication
(10) Pub. No.: US 2015/0169334 A1
(43) Pub. Date: Jun. 18, 2015

(54) METHOD FOR CUSTOMIZING DEVICE INITIAL SETTINGS IN INFORMATION PROCESSING SYSTEM

(71) Applicant: NEC CORPORATION, Tokyo (JP)

(72) Inventor: Noboru Iijima, Tokyo (JP)

(73) Assignee: NEC CORPORATION, Tokyo (JP)

(21) Appl. No.: 14/414,491

(22) PCT Filed: Jul. 3, 2013
(86) PCT No.: PCT/JP2013/068253

§ 371 Date: Jan. 13, 2015

(30) Foreign Application Priority Data
Jul. 19, 2012 (JP) 2012-160354

(51) Int. Cl. G06F 9/44; G06F 17/30

(52) U.S. Cl. CPC G06F 9/4411; G06F 17/30607; G06F 17/30575

(57) ABSTRACT

An information processing system which performs a device initial setting customization method includes a CPU, a monitoring control unit, an object initial setting table, and a database of instance data. When a device is newly mounted on a predetermined slot of a shelf, the monitoring control unit newly generates instance data by referring to the object initial setting table and store the instance data in the database. When the new instance data is required to be corrected for each object, the monitoring control unit corrects the new instance data using object initial setting correction data. When the new instance data is required to be corrected for each instance, the monitoring control unit corrects the new instance data using instance initial setting correction data.

### TECHNICAL FIELD

The present invention relates to a method for automatically customizing device initial settings when the device is installed in an information processing system.

The present application claims priority to Japanese Patent Application No. 2012-160354, filed Jul. 19, 2012, and the contents of this application are incorporated herein by reference in its entirety.

### BACKGROUND ART

Manufacturers (makers) have recently needed to adequately understand device functions in response to a demand from a small customer in a business to business (BtoB) electronic commerce using online. In addition, incorporating a demand hearing from a small customer into the device functions and designing an information processing apparatus or an information processing system including the relevant device functions becomes the business mainstream between enterprises. For example, a basic apparatus is first developed based on this trend and also in view of development cost containment, and then changing of initial settings of the basic apparatus, function enhancement, and addition of a device are performed to match customer's needs.

As described above, customization of device initial settings (or reconfiguration of device) is required to cope with the function enhancement and addition of the device. The required device initial settings are different in each customer depending on operation conditions of the customer, and thus an initial setting database is required to be newly developed for each customer and a scale of the development is increased. Therefore, instead of newly developing an initial setting database for each customer, development of a system which can correct only an initial setting associated with a specific function needed for the customer is desired.

There are various publicly known documents regarding installation and customization of a device driver. For example, in PTL 1, an installation method of a printer driver is disclosed which is capable of easily customizing a setting of the printer driver to an initial setting desired by a printer manager in an information processing apparatus. Specifically, a server apparatus creates an installer including a plurality of pieces of setting changing data (customizing data) under a predetermined environment and transmits the installer to a client apparatus. A user selects a desired initial setting from options using the installer received by the client apparatus and customizes the initial setting of the printer driver.

In PTL 2, a technique for improving customization operability of a device driver in an information processing apparatus is disclosed. Specifically, in an information processing apparatus which customizes a device driver for controlling a printing apparatus by a property setting, a plurality of device drivers is specified and individual property information is set to the plurality of device drivers in response to a customization instruction. In PTL 3, a technique for editing a default value of a print setting according to a driver installation environment is disclosed. Specifically, a default print setting applied at printer driver installation is edited using a customization tool in an information processing apparatus. For example, when a stamp setting button of a customization tool is clicked in the information processing apparatus, a user interface screen is displayed, and parameters obtained by changing characters, size, color, position, inclination, and font of the stamp in response to detail settings of a user is stored. If an editing instruction is a change of control, a user interface screen for that is displayed, and the user can change parameters. The relevant parameters are stored in a storage device as customized default print settings and loaded to a CPU when the printer driver is installed. In PTL 4, a device driver installer is disclosed which is capable of reducing a development burden using a comprehensive device driver and reducing a burden on user by automatically performing customization appropriate for a model to be installed. Specifically, a terminal apparatus on a client side obtains a type ID (a series ID+a group ID) of an image forming apparatus and extracts the series ID determined by an interface from the type ID to determine the comprehensive device driver to be used. In addition, the comprehensive device driver is reconfigured in response to a group ID indicating a function group and a function of the image forming apparatus and installed to the terminal apparatus on the client side.

### CITATION LIST

### Patent Literature

PTL 1: Japanese Patent No. 4181973

PTL 2: Japanese Patent No. 4812093

PTL 3: Japanese Patent No. 4863450

PTL 4: Japanese Unexamined Patent Application Publication No. 2010-086313

### SUMMARY OF INVENTION

### Technical Problem

The technique described in PTL 1 is effective for easily customizing a printer driver to an initial setting desired by a printer manager, however, customization includes detail initial settings required at the time of device addition, such as an alarm threshold value of a light level and an ON/OFF setting of a specific function, which are caused by a difference in operation conditions on customers, and it is inconvenient for a user. The technique described in PTL 2 is effective for improving customization operability of a device driver, however, there is a problem similar to that in the technique described in PTL 1. The technique described in PTL 3 is for editing a default value of a print setting according to a driver installation environment and effective for customizing a device driver, however, there is a problem similar to that in the technique described in PTL 1. The technique described in PTL 4 uses a comprehensive device driver and is effective for reducing a burden of device development and a burden on the user since it automatically performs customization appropriate for a model to be installed. However, in the technique described in PTL 4, there is a plurality of comprehensive device drivers, and there is a problem that update of the device initial settings is not performed at registration of an object and a mounting position (a slot number) of an added device to be mounted on a shelf is not recognized when the device initial settings are updated.

According to a conventional customization method of a device driver, an initial setting of instance data is required to be manually input point by point using a command for each added device when a device initial setting is updated. Further, according to the conventional customization method of a device driver, a user initial setting database (for example, UDF: User Database Format) matching customer's needs is required to be designed separately from an initial setting database, and the user initial setting database is used when the device initial setting is corrected. However, since all initial settings are described in the UDF, all of the initial settings are required to be re-registered even if minor correction is performed on the initial setting, and there is a possibility that software processing steps are increased and a careless mistake is made in a software design. In addition, the UDF is backup data, and monitoring control software is required to be re-started separately in order to validate the backup data in an actual operation.

An object of the present invention is to provide a device initial setting customization method of an information processing apparatus which is capable of correcting an initial setting regarding a specific function of a device without correcting a user initial setting database when a device initial setting is corrected.

### Solution to Problem

The present invention relates to an information processing system which includes: an object initial setting table which stores initial settings of a plurality of objects to be registered in association with a plurality of devices to be mounted on a shelf; a database which stores a plurality of pieces of instance data generated based on the plurality of objects; and a monitoring control unit which generates new instance data by referring to the object initial setting table for a newly mounting device and registers the new instance data to the database. When the new instance data is required to be corrected for each object, the monitoring control unit corrects the new instance data using object initial setting correction data. When the new instance data is required to be corrected for each instance, the monitoring control unit corrects the new instance data using instance initial setting correction data.

The present invention relates to a device initial setting customization method applied to an information processing system including an object initial setting table and a database of instance data. The method includes: generating new instance data by referring to the object initial setting table for a device to be newly mounted to a shelf and registering the new instance data to the database; and correcting the new instance data using object initial setting correction data when the new instance data is required to be corrected for each object and correcting the new instance data using instance initial setting correction data when the new instance data is required to be corrected for each instance.

The present invention relates to a computer-readable storage medium storing a program for customizing a device initial setting by a computer connected to an object initial setting table and a database of instance data.

### Advantageous Effects of Invention

According to the present invention, when a user just registers object data in a monitoring control unit, a comprehensive device initial setting of an object can be automatically performed and an initial setting can be corrected in detail for a specific device. In other words, the present invention provides advantageous effects (1) and (2).

(1) When device initial settings are corrected to match customer's needs, there is no need to correct a user initial setting database (UDF), and initial settings of specific function and device can be arbitrary corrected.
(2) When a device is added to a shelf, monitoring control software automatically corrects the device initial settings, so that a user does not need to manually perform an operation.

### BRIEF DESCRIPTION OF DRAWINGS

FIG. 1 is a block diagram illustrating an information processing system to which a device initial setting customization method according to an exemplary embodiment of the present invention is applied.

FIG. 2 is a flowchart illustrating a conventional device initial setting customization method.

FIG. 3 is a flowchart illustrating the device initial setting customization method according to the exemplary embodiment of the present invention.

FIG. 4 is a list describing definitions of terms used in descriptions of the exemplary embodiment of the present invention.

FIG. 5 is explanatory diagrams illustrating a series of processing from object registration to initial setting correction when a device is expanded in the information processing system.

### DESCRIPTION OF EMBODIMENTS

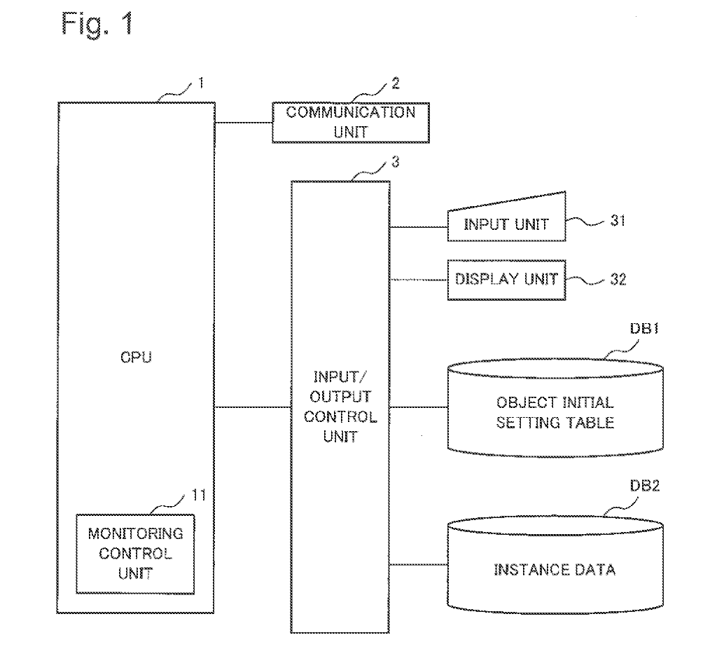

The present invention will be described in detail using exemplary embodiments with reference to the attached drawings. FIG. 1 shows an information processing system to which a device initial setting customization method is applied. The information processing system includes a CPU 1, a communication unit 2, and an input/output control unit 3. The CPU 1 includes a monitoring control unit 11. The input/output control unit 3 is connected to an input unit 31, a display unit 32, an object initial setting table DB1 (database), and instance data DB2 (database). A configuration according to the exemplary embodiment of the present invention includes the CPU 1, the monitoring control unit 11, the input/output control unit 3, the display unit 32, the object initial setting table DB1, and the instance data DB2, and the communication unit 2 and the input unit 31 are optional components.

The CPU 1 controls entire information processing system and executes processing of the monitoring control unit 11. The information processing system is connected to an Internet and a mobile phone network via the communication unit 2. The input/output control unit 3 controls the input unit 31, the display unit 32, the object initial setting table DB1, and the instance data DB2. The input unit 31 inputs a user operation to register a device object and to updates an initial setting of instance data. The display unit 32 displays input data on a screen to allow a user to check it and displays a progress state of customization processing (device reconfiguration processing) of the device initial setting.

The object initial setting table DB1 is a database which stores an object initial setting table. The instance data DB2 is a database which stores instance data.

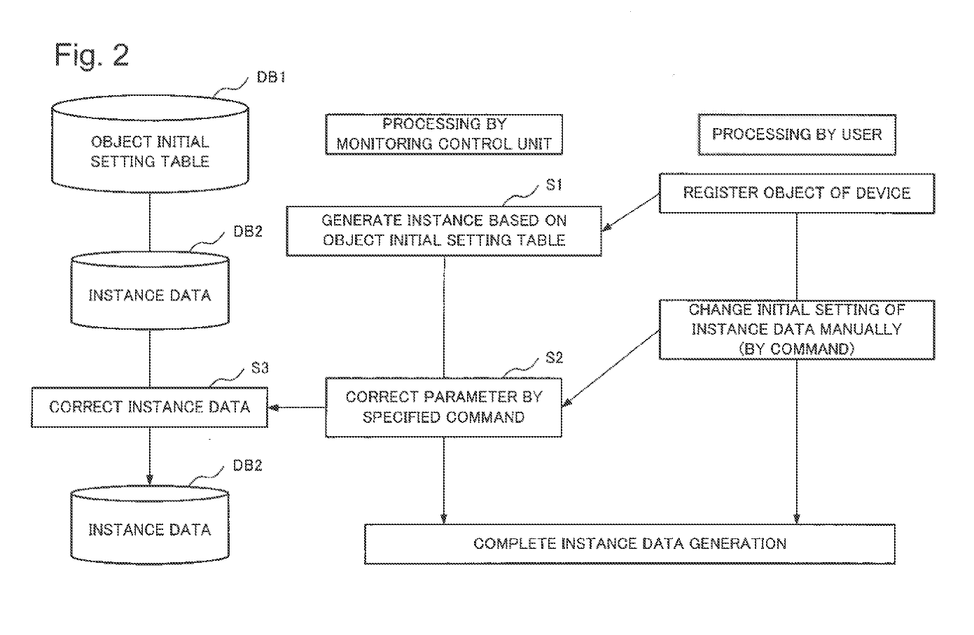

Before describing the device initial setting customization method according to the present exemplary embodiment, a conventional device initial setting customization method and a problem thereof are described by considering the information processing system in FIG. 1. FIG. 2 is a flowchart illustrating the conventional device initial setting customization method. When a user registers a device object in the information processing system, the monitoring control unit 11 generates instance data based on the object initial setting table DB1, records the instance data to the instance data DB2, and enables a device function (step S1). A user may register a device object in the monitoring control unit 11 by operating the input unit 31. Alternatively, a device object may be registered in the monitoring control unit 11 from another terminal apparatus via the communication unit 2.

Instance data to be recorded to the instance data DB2 is set to a defaults value based on the object initial setting table DB1. However, initial settings at the time of device addition, such as an alarm threshold value of a light level and ON/OFF of a specific function, are different depending on a difference in operation conditions on customers, and the initial settings are required to be corrected to match customer's needs in the conventional device initial setting customization method. Therefore, a user needs to manually input a command for initially setting instance data to the information processing system for each added device. The monitoring control unit 11 corrects the initial setting of the instance data recorded in the instance data DB2 according to the command (steps S2 and S3).

In the conventional device initial setting customization method, a user initial setting database (UDF) matching customer's needs may be designed separately from the object initial setting table DB1, and the UDF may be referred to when the device initial setting is corrected. However, all of the device object initial settings are required to be described in the UDF, and man-hour of software processing is increased and a careless mistake is made in a software design. In addition, the UDF is backup data, and the monitoring control unit 11 is required to be re-started in order to validate the backup data in an actual operation.

The device initial setting customization method according to the present exemplary embodiment allows a user to add a device which is not in a full specification to construct an apparatus specification that the user wants. Further, a part of a specification of a device having a full specification can be replaced. A user does not add or replace a device having an arbitrary specification, and can add a predetermined device specified by a developer side (a maker side) to a slot having a predetermined number in a predetermined shelf according to an apparatus configuration.

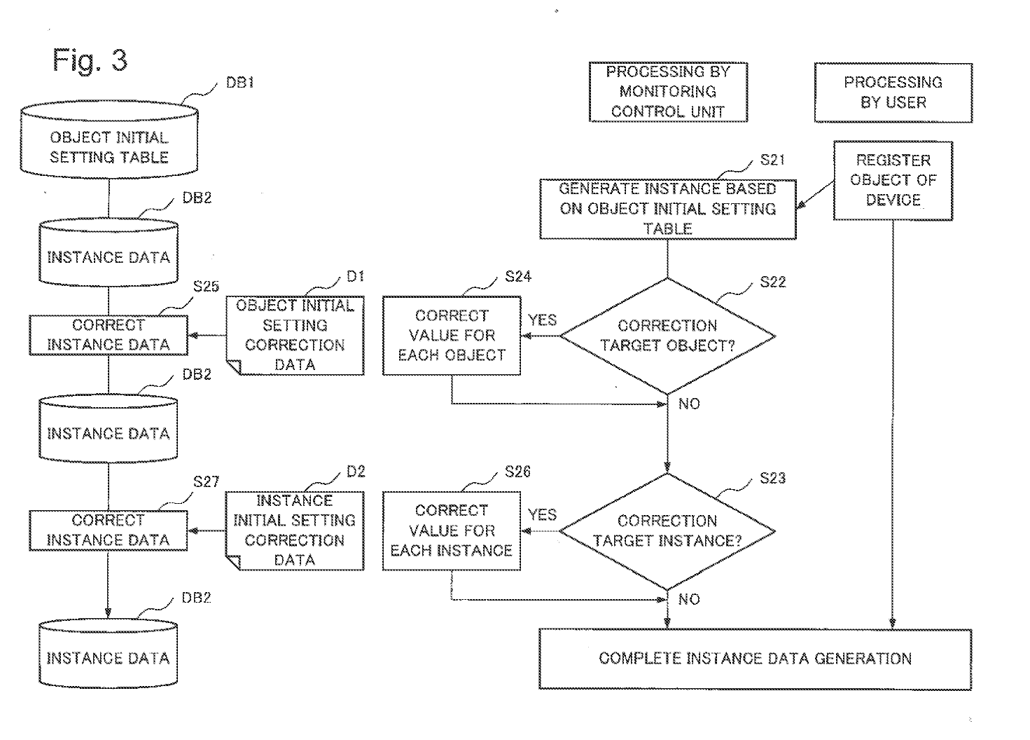

FIG. 3 is a flowchart illustrating the device initial setting customization method according to the exemplary embodiment of the present invention. The flowchart shows processing for correcting instance data of a device. The device initial setting customization method is described in detail with reference to FIG. 1 and FIG. 3. When a user registers an object including a device in the monitoring control unit 11, the monitoring control unit 11 generates instance data for the instance data DB2 based on the object initial setting table DB1 and enables a device function (step S21).

Next, the monitoring control unit 11 examines whether the object is a correction target (step S22). When the object of the instance data is the correction target, the monitoring control unit 11 corrects the instance data in the instance data DB2 for each object using object initial setting correction data D1 (steps S24 and S25).

Next, the monitoring control unit 11 examines whether the instance data recorded in the instance data DB2 is the correction target (step S23). When the instance data is the correction target, the monitoring control unit 11 individually corrects the instance data in the instance data DB2 using instance initial setting correction data D2 (steps S26 and S27). Accordingly, generation of instance data matching operation needs of a customer is completed, and the instance data is recorded to the instance data DB2. Then, the CPU 1 performs the device initial setting based on the instance data.

The object initial setting correction data D1 and the instance initial setting correction data D2 matching the operation needs of the customer are preliminarily stored in the monitoring control unit 11. The object initial setting correction data D1 and the instance initial setting correction data D2 may be stored in the monitoring control unit 11 when control software of the monitoring control unit 11 is installed. Alternatively, the monitoring control unit 11 may download the object initial setting correction data D1 and the instance initial setting correction data D2 and store therein after control software is installed to the monitoring control unit 11.

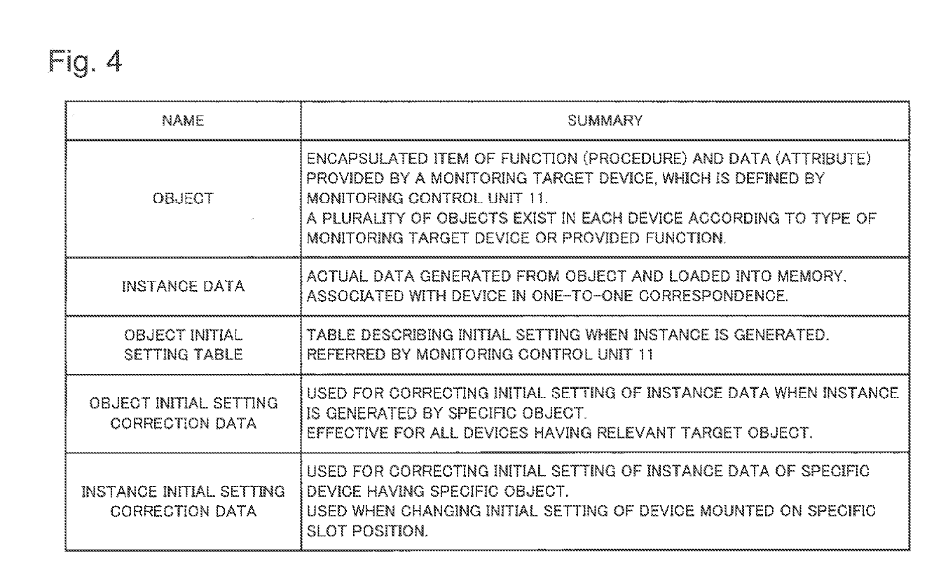

FIG. 4 is a list describing definitions of terms used in the present exemplary embodiment. “Object” is an item in which a function (procedure) and data (attribute) provided by a monitoring target device defined by the monitoring control unit 11 are encapsulated. There are a plurality of objects in each apparatus according to a type of the monitoring target device or the provided function. “Instance data” is actual data generated from the object and loaded into a memory. The actual data is associated with the device in one-to-one correspondence. “Object initial setting table” is a table in which initial settings when the instance data is generated are recorded. The object initial setting table is registered in the database DB1 and referred to by the monitoring control unit 11 when a user registers an object of a desired device. “Object initial setting correction data” is used when instance data is generated based on a specific object for correcting initial settings of the instance data. The object initial setting correction data is effective for all devices having a specific object. “Instance initial setting correction data” is used for further correcting the initial settings of the instance data of a specific device having the specific object. The instance initial setting correction data is used by the monitoring control unit 11 when only initial settings of a device to be mounted on a specific slot position are changed.

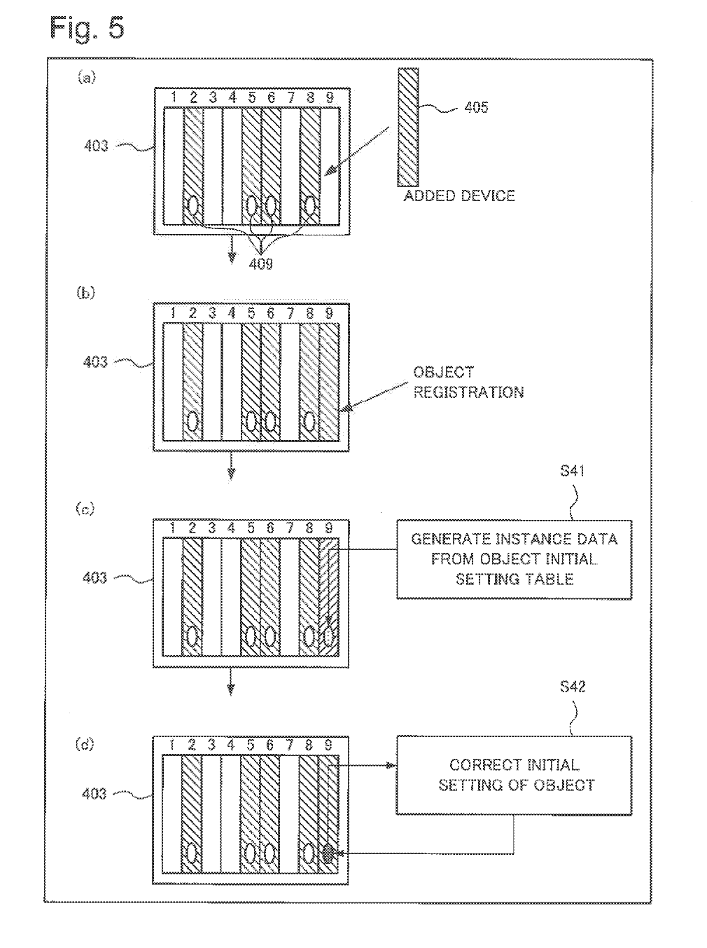

FIG. 5 is explanatory diagrams illustrating a series of processing from object registration to initial setting correction when a device is expanded in the information processing system. Slots No. 1 to No. 9 are built into a shelf 403 shown in (a) of FIG. 5 to (d) of FIG. 5. In the shelf 403 shown in (a) of FIG. 5, slots on which devices are mounted (hatching portions) and slots on which devices are not mounted (empty portions) are mixed. Objects 409 are registered in the monitoring control unit 11 to enable functions of the mounted devices in the shelf 403. Here, an added device 405 is mounted on a slot (No. 9) in the shelf 403 shown in (a) of FIG. 5. As shown in (b) of FIG. 5, a user mounts the added device 405 on the slot (No. 9) in the shelf 403. Then, the user registers the object to enable a function of the added device 405.

As shown in (c) of FIG. 5, the monitoring control unit 11 refers to the object initial setting table DB1 to generate instance data associated with the added device 405 (step S41). As shown in (d) of FIG. 5, when an object regarding the instance data is a correction target of initial settings, the monitoring control unit 11 corrects the initial settings of the object using the object initial setting correction data D1 (step S42). When the initial settings of the instance data of the added device 405 mounted on the slot (No. 9) in the shelf 403 is corrected in detail, the monitoring control unit 11 corrects the initial settings of the added device 405 in detail using the instance initial setting correction data D2, which is preliminarily stored and is associated with the slot (No. 9).

In the device initial setting customization method according to the present exemplary embodiment, when a user just registers object data in the information processing system, a comprehensive device initial setting of an object can be corrected and an initial setting can be corrected in detail regarding a specific device. As described above, the apparatus configuration which matches detailed specifications can be accurately constructed in response to customer's needs. Further, a developer side (a maker side) of a device can provide the apparatus configuration matching user's requirement by just creating minimum initial setting correction data, and thus a development cost of the device can be reduced. Furthermore, device initial setting correction data is divided into object data and instance data which are separately used in accordance with a purpose of use. More specifically, object data is used when initial settings common to specific functions are corrected, and instance data is used when initial settings of a specific device which are finely changed in response to a specification environment and conditions of each user are corrected.

The present invention is not limited to the present exemplary embodiment and can create many variations within a scope of the invention defined in the attached claims. For example, in the present exemplary embodiment, a user registers an object and corrects device initial settings when adding a device, however, the present invention can be applied to not only when a device is added but also when an initial setting of an existing device is corrected in the middle of a device operation. For example, the object initial setting correction data D1 and the instance initial setting correction data D2 are downloaded to the monitoring control unit 11 in the middle of the device operation, and initial settings of specific object data and specific instance data may be corrected.

At least a part of processing of the monitoring control unit 11 to which the device initial setting customization method according to the present exemplary embodiment is applied may be executed by a computer. Further, a program for causing a computer to execute the procedure illustrated in the flowchart in FIG. 3 may be stored in a computer-readable storage medium, such as a semiconductor memory, a CD-ROM, and a magnetic tape. A microcomputer, a personal computer, a general-purpose computer, and the like may read the program from the storage medium and realize the device initial setting customization method.

### INDUSTRIAL APPLICABILITY

The present invention provides a device initial setting customization method of an information processing system and is suitably applicable to a various computers, servers, and clients.

### REFERENCE SIGNS LIST

1 CPU

2 Communication unit

3 Input/output control unit

11 Monitoring control unit

31 Input unit

32 Display unit

DB1 Object initial setting table (database)

DB2 Instance data (database)

403 Shelf

405 Added device

409 Object

1. An information processing system comprising:
an object initial setting table which stores initial settings of a plurality of objects to be registered in association with a plurality of devices to be mounted on a shelf;
a database which stores a plurality of pieces of instance data generated based on the plurality of objects; and
a monitoring control unit which generates new instance data by referring to the object initial setting table for a newly mounting device and registers the new instance data to the database,
wherein when the new instance data is required to be corrected for each object, the new instance data is corrected using object initial setting correction data, and when the new instance data is required to be corrected for each instance, the new instance data is corrected using instance initial setting correction data.

2. A device initial setting customization method applied to an information processing system including an object initial setting table and a database of instance data, the device initial setting customization method comprising:
generating new instance data by referring to the object initial setting table for a device to be newly mounted to a shelf and registering the new instance data to the database; and
correcting the new instance data using object initial setting correction data when the new instance data is required to be corrected for each object and correcting the new instance data using instance initial setting correction data when the new instance data is required to be corrected for each instance.

3. A computer-readable storage medium storing a program for customizing a device initial setting by a computer connected to an object initial setting table and a database of instance data, the program comprising a process of:
generating new instance data by referring to the object initial setting table for a device to be newly mounted to a shelf and registering the new instance data to the database; and
correcting the new instance data using object initial setting correction data when the new instance data is required to be corrected for each object and correcting the new instance data using instance initial setting correction data when the new instance data is required to be corrected for each instance.
